(19) United States
(12) Patent Application Publication
(10) Pub. No.: US 2013/0098334 A1
(43) Pub. Date: Apr. 25, 2013

(54) Fuel Metering Device for an Internal Combustion Engine

(71) Applicant: Alfred Luhmann, Bad Essen (DE)

(72) Inventor: Alfred Luhmann, Bad Essen (DE)

(73) Assignee: A. Luhmann GmbH, Bad Essen (DE)

(21) Appl. No.: 13/806,164

(22) PCT Filed: Jun. 22, 2011
(86) PCT No.: PCT/EP2011/003085

§ 371 Date: Dec. 21, 2012

(30) Foreign Application Priority Data
Jun. 22, 2010 (DE) 10 2010 024 635.2

(51) Int. Cl. F02M 69/52

(52) U.S. Cl. CPC F02M 69/52
USPC 123/446

(57) ABSTRACT

The invention relates to a fuel metering device in particular for a self-igniting air-compressing internal combustion engine, comprising a fuel pump for delivering a fuel, wherein the fuel can be withdrawn from a tank and supplied via a high-pressure pump to an injection system of the internal combustion engine, and wherein excess fuel can be recirculated from the injection system via a recirculating line in the injection system, and wherein the tank is designed as a pressure mixing receptacle having a vapour pressure buffer chamber to receive a first fuel such as diesel fuel, rape-seed oil, soyseed oil, sunflower oil, palm oil or fats and a further fuel such as a liquefied petroleum gas (LPG fuel), and a pressurised fuel mixture formed of the first fuel and the second fuel can be withdrawn from the pressure mixing receptacle serving as a tank via an extraction valve and supplied to the high-pressure pump of the injection system via the fuel pump designed as a booster pump. It is characterised in that the withdrawal of the pressurised fuel mixture via the extraction valve takes place via a wall located in the lower region of the tank, such that a static pressure acts on the extraction valve and the fuel pump designed as a booster pump is disposed down-stream of the extraction valve in the flow direction of the fuel mixture outside of the pressure mixing receptacle, wherein a pressure relief and bypass valve for recirculating the fuel mixture via the recirculating line to the pressure mixing vessel is provided downstream of the fuel pump and upstream of the injection system in the fuel flow direction.

The invention relates to a fuel metering device, in particular for a self-igniting air-compressing internal combustion engine, comprising a fuel pump for conveying a fuel, wherein the fuel can be removed from a tank and supplied via a high-pressure pump to an injection system of the internal combustion engine and wherein excess fuel can be returned from the injection system via a return line in the injection system, and wherein the tank is designed as a pressurized mixing container having a vapor pressure buffer chamber for receiving a first fuel such as diesel fuel, rapeseed oil, soybean oil, sunflower seed oil, palm oil or fats and a further fuel such as liquefied petroleum gas (LPG fuel), and wherein a pressurized fuel mixture that is formed of the first fuel and the second fuel can be removed from the pressurized mixing container serving as a tank via an extraction valve and supplied to the high-pressure pump of the injection system via the fuel pump embodied as a booster pump.

Fuel metering devices are, for example, furnished with a common rail injection system in order to utilize diesel fuels e.g. in a map-controlled injection system and in order to optimize thereby the combustion process and the engine operating properties and to reduce particulate emissions.

In order to reduce particulate emissions, fuel metering devices for supplying fuel mixtures are also known. For example, DE 10 2004 011 414 A1 discloses to combine, by injection of a fuel mixture of fuels of different properties, the diesel engine combustion with constant volume combustion of the Otto engine in order to obtain therefrom advantages with respect to performance and emissions of fuels.

This document discloses to design an internal combustion engine such that a fuel mixture of LPG fuel that is to be kept liquid at a relatively minimal overpressure and of a diesel fuel is directly injected into the combustion chamber wherein the internal combustion engine is designed as an air-compressing internal combustion engine and has two fuel tanks for the two fuels. The two tanks have arranged downstream thereof a pressurized mixing container from which the fuel mixture is then supplied by a high-pressure pump to the injection system of the internal combustion engine.

DE 10 2004 011 414 provides that the fuel pumps are provided within the respective fuel tank so that there are no repair possibilities regarding the fuel pumps when the tank is full. Moreover, a pressurized mixing container is provided that is filled to the limit so that there is no expansion space available and this constitutes a significant burst risk.

DE 203 10 824 U1 discloses an internal combustion engine with high-pressure injection of a liquid fuel mixture of the aforementioned kind in which a fuel mixture is provided in the tank that is designed as a pressurized mixing container with an upper buffer chamber for receiving the first fuel such as diesel fuel and a furtherfuel such as LPG fuel (butane) and within the pressurized mixing container the fuel pump is arranged for removal of the fuel. The fuel to be conveyed by the fuel pump is fed optionally to a filter, optionally to a further fuel pump and the high-pressure pump for further conveyance into the injection system. From the injection system an excess fuel mixture can be returned again after lowering the pressure via a return line to the pressurized mixing container.

A disadvantage in this connection is that again the fuel pump is arranged within the pressurized mixing container without there being a repair possibility when the tank is full. Moreover, it is disadvantageous that the pumps are subjected to increased wear because the excess fuel is to be returned from the injection device to the pressurized mixing container; this leads to increased stress of the fuel pumps, in particular of the high-pressure pump. It is also disadvantageous that in case of restarting the engine when it is still at operating temperature bubble formation in the lines is almost unavoidable as a result of evaporated components in the fuel mixture. This leads to extremely bad restarting properties of the engine up to the point of engine failure.

It is therefore an object of the present invention to provide a fuel metering device of the aforementioned kind that initially provides the possibility to remove fuel as bubble free as possible but, at the same time, to service and repair engine parts such as the pumps from the exterior. Moreover, preferably the fuel metering device should be able to be further developed so that it enables improved starting properties of the engine even when still at operating temperature.

As a solution to this object, the fuel metering device of the afore mentioned kind is characterized in that the removal of the pressurized fuel mixture is realized via the removal valve via a wall that is arranged in the lower area of the tank so that a static pressure loads the removal valve and in that the fuel pump, which is designed as a booster pump, is arranged downstream of the removal valve in the flow direction of the fuel mixture outside of the pressurized mixing container, wherein, arranged downstream of the fuel pump and upstream of the injection system in the flow direction of the fuel, an overpressure and bypass valve for returning the fuel mixture through the return line into the pressurized mixing container is provided.

In this way, a fuel metering device is provided in which a mixture of a fuel for diesel engines is used, wherein also mixing with propane and butane, produced from biomass of renewable raw materials, can be employed.

This fuel mixture can be supplied as a ready pressurized fuel mixture to the pressurized mixing container serving as a fuel tank and carried onboard. With appropriate valves on the mixing container, this fuel mixture is maintained under pressure. This fuel mixture can be, for example, pressed at pressurized filling stations into the pressurized mixing container serving as the vehicle tank. This can be realized by means of non-stationarily or stationarily operated pressurized filling stations. Alternatively, it is of course also possible to pump e.g. diesel fuel, rapeseed oil, soybean oil, sunflower seed oil, palm oil or fats separately into the pressurized mixing container serving as the tank and to subsequently admix the pressurized liquid gas such as propane or butane, wherein within the tank such a pressure is automatically produced that at said pressure diesel fuel, rapeseed oil, soybean oil, sunflower seed oil, palm oil or fats and the liquid gas mix with each other such that it can be supplied directly to the injection system of the internal combustion engine as a pressurized fuel mixture. The special pressurized mixing container as it is provided according to German patent application 10 2008 063 278 is no longer needed. Since the gas liquid has a density of approximately 500 g/l, rapeseed oil, for example, a density of approximately 900 g/l, the sedimentation that is usually occurring is prevented by pressure build-up within the pressurized mixing system. Since rapeseed oil is combusted nearly CO₂-reduced and LPG fuel is combusted nearly soot-free, significant emissions can be saved. Rapeseed oil, for example, can be even used without it being necessary that the internal combustion engine must first run up to operating temperature. Instead, a rapeseed oil-butane or rapeseed oil-propane mix can be adjusted such that the internal combustion engine can be operated as with a conventional diesel fuel of today. When butane and propane are produced from biomass, a completely CO₂-neutral combustion in the internal combustion engine can take place.

Even a highly viscous vegetable oil becomes as thin as a diesel fuel by admixture of pressurized propane/butane liquid and atomizes during injection as finely as a conventional diesel fuel. In this way, a very clean combustion accompanied by an improved emissions quality can be obtained. Moreover, the otherwise conventional installation of the conventional vegetable oil treatment device for enabling a start of the engine at cold temperatures is obsolete.

By producing this fuel mixture, an ideal combination of renewable regenerative biofuels and cleanly combusting liquid fuels is possible. By use of biogenic propane/butane and vegetable oil an almost 100% CO₂ neutrality of the fuel is enabled. Since for a mixing ratio of 50:50 only half of the quantity of vegetable oil is injected, an oil change interval can be expanded by twice the amount based on this. The pressurized mixing container is to be provided absolutely safely within a vehicle. All valves that are provided in the pressurized mixing container are to be protected and, for example, to be provided with a non-return device of a spring. An appropriate protective housing can be designed to be oversized and nearly form-fittingly, wherein an overpressure opening can be designed to be lockable.

As a whole, in this way a fuel metering device is made available with which a conventional internal combustion engine can be retrofitted which can then be operated with a significantly reduced emissions behavior and, as a result of the price advantages of the employed fuel, can also be operated significantly less expensively.

Since the removal valve is arranged at a wall in a lower area of the tank, there is always the static pressure of the fuel mixture acting on the removal valve so that upon removal a bubble formation is prevented. The fuel pump adjoining in the flow direction and embodied as a booster pump can therefore remove the fuel mixture at the required pressure and convey it bubble-free. By means of the overpressure and bypass valve that is arranged in the flow direction upstream of the injection system, the fuel mixture can be returned in case of overpressure in an apparatus-protective way into the pressurized mixing container.

It is particularly advantageous when between the high-pressure pump and the booster pump the overpressure and bypass valve is arranged in order to return therethrough the fuel mixture to the pressurized mixing container in case of overpressure. In this way, the high-pressure pump is significantly stressed less.

It is especially preferred when a second tank with a vapor pressure buffer chamber for receiving the first fuel such as diesel fuel, rapeseed oil, soybean oil, sunflower seed oil, palm oil or fats is provided as a starter fuel. In the case of shutting down the engine and a planned restart, bubble formation can occur otherwise in the supply system of the fuel mixture which may prevent restarting of the self-igniting air-compressing internal combustion engine. For this situation, the diesel fuel or other fuels without LPG proportion is used as a starter fuel wherein the components provided for this purpose are designed such that they are capable of removing possibly existing bubbles from the fuel mixture supply system.

In accordance with the invention, it is provided that via the tank of the starter fuel via a conveying pump the starter fuel is removable and can be supplied by means of the high-pressure pump to the injection system, namely again by means of the high-pressure pump wherein, prior to this, the booster pump of the pressurized mixing container and the conveying pump of the tank of the starter fuel as well as a corresponding switching valve in the supply line of the fuel mixture supply system is controlled by a control unit in such a way that the switching valve is switched in such a way that the supply line for the starter fuel is released, the booster pump of the pressurized mixing container for the fuel mixture is switched off, and the fuel pump for the starter fuel is switched on. This can be done after stopping the internal combustion engine independent of the measure of a one restart wherein the fuel pump for the starter fuel generates a slightly greater pressure than the booster pump of the pressurized mixing container so that the starter fuel is capable of, as a result of the overpressure, forcing out the fuel mixture and also the bubbles from the supply system of the fuel metering device, for which purpose also appropriate valves in the return lines are opened. Upon restarting, starting of the engine is then realized solely by means of the starter fuel, for example, the diesel fuel; this is possible without problems. After the starting process, the control unit ensures switching to operation with the fuel mixture so that a further safe operation of the total combustion engine with the fuel mixture is enabled. Accordingly, the operating properties of the engine can be significantly improved and the other advantages of operating the internal combustion engine with the fuel mixture are not impaired or hardly impaired.

For further explanation reference is being had to the dependent claims, the following description, and the drawings. The drawings show in:

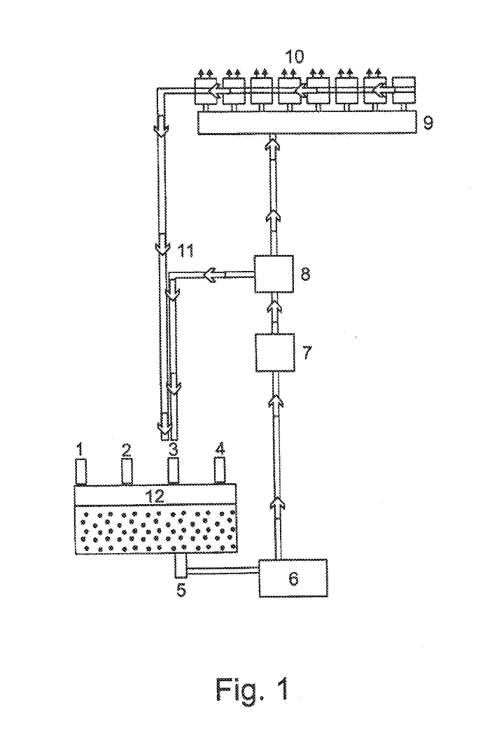

FIG. 1 illustrates a device schematic of the fuel metering device in connection with the injection system of an internal combustion engine;

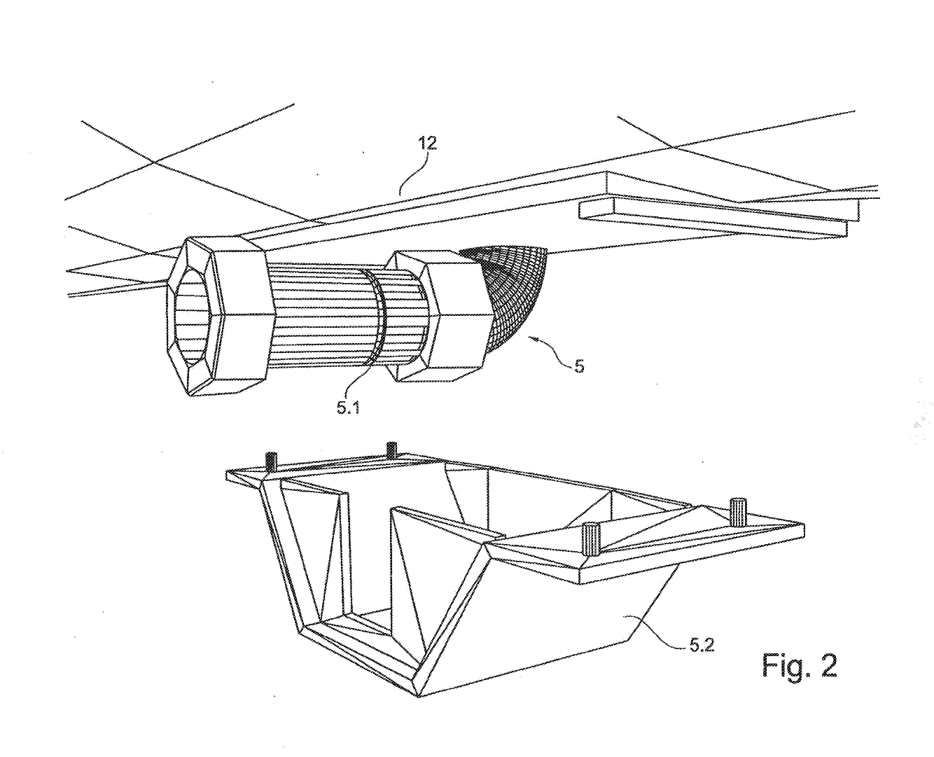

FIG. 2 schematically the lower area of a tank with the removal valve and a protective device in the not yet mounted state;

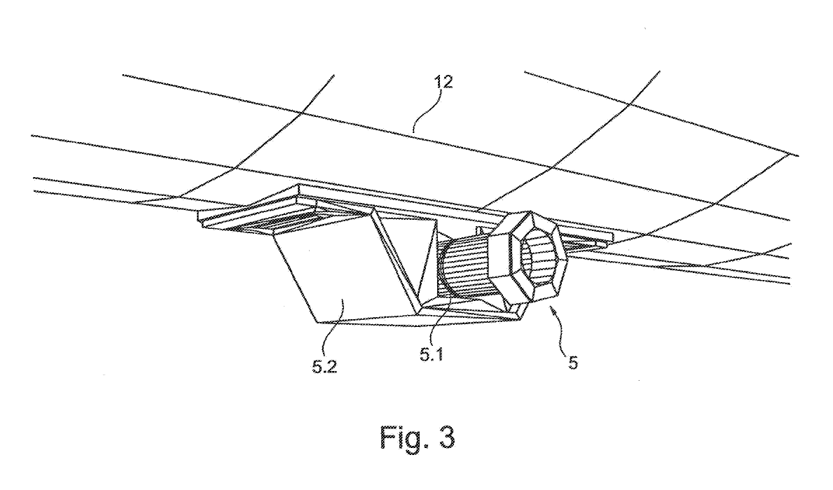

FIG. 3 an illustration in analogy to FIG. 2 with mounted protective device;

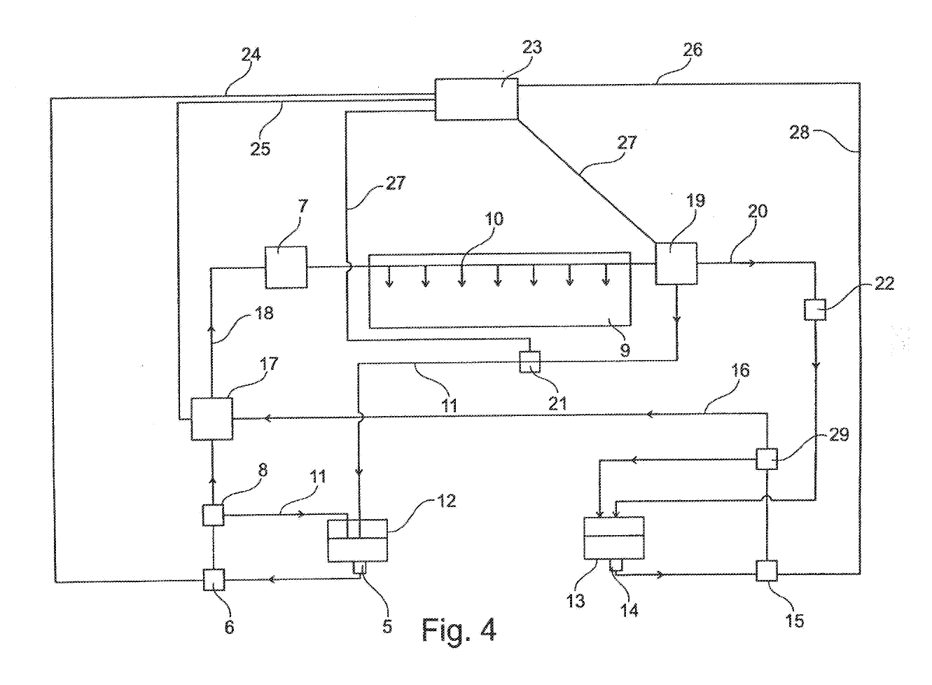

FIG. 4 illustrates a device schematic of the fuel metering device in connection with the injection system of the internal combustion engine in which in addition a second tank for a starter fuel such as a diesel fuel is provided.

In the drawing, a safety valve with integrated fill stop in order to ensure a vapor buffer chamber of approximately 15% of the container volume is generally referenced by 1, a filling valve by 2, a return line by 3, and by 4 a content gauge of a tank that is embodied as a pressurized mixing container 12 of the internal combustion engine, not illustrated, is referenced. Within the pressure tank 12 the pressurized fuel mixture of diesel fuel, rapeseed oil, soybean oil, sunflower seed oil, palm oil or fats and an LPG fuel such as propane or butane is illustrated. Above the filling level, a vapor pressure buffer chamber is provided; in the illustrated embodiment, the mixture, as a ready pressurized mixture, has been introduced through the filling valve.

At the lowermost location of the pressure tank 12, i.e., at a location where a static pressure exists as a result of the filled-in fuel, at the removal line which comprises the removal valve 5, a possible gas bubble formation in the line is safely prevented. This is assisted by the booster pump 6 that is arranged downstream of the removal valve 5 from where the pressurized fuel mixture is supplied to the high-pressure pump 7 with which the fuel mixture is then brought to a pressure of approximately 1,600 bar. The high-pressure pump 7 has downstream thereof an overpressure and bypass valve 8. From here, the pressurized fuel mixture can be supplied to the common rail injection system 9 with the injection elements 10. From here, excess fuel can be returned again via the return line 11 to the pressurized mixing container 12. In another position of the overpressure and bypass valve, from this valve excess fuel can moreover be returned by line 11 also into the pressurized mixing container 12.

In FIGS. 2 and 3 the pressurized mixing container 12 with removal valve 5 is indicated. At 5.1 a rated breakage point is indicated. In the interior, not illustrated in detail, two balls are provided that are spring-loaded and, upon breakage of a part of the valve at the rated breakage point, are moved against respectively ball seats and in this way safely seal the fuel tank. Moreover, the part 5.2 can be positioned as a protective cover onto the removal valve, as is illustrated in more detail in FIG. 3. Accordingly, the removal valve 5 is closed off safely up to the rated breakage point 5.1 relative to the exterior.

In FIG. 4, the device schematic of FIG. 1 is illustrated with identical reference characters of the parts, supplemented by device components with a second tank 13 for a starter fuel such as, for example, a diesel fuel. This additional tank 13 is also provided with a buffer chamber. Through a removal valve 14 by means of conveying pump 15 starter fuel is to be conveyed through the supply line 16 to a switching valve 17. By means of this switching valve 17, the starter fuel can flow to the supply line 18 of the fuel mixture of the pressurized mixing container 12 and from there via the high-pressure pump 7 into the injection system 9, 10.

A further switching valve 19 of the injection device 9, 10 is arranged downstream, from which the return line 11 of the fuel mixture extends to the pressurized mixing container 12 and a further return line 20 extends to the tank 13 for the starter fuel. In both return lines 11 and 20 control devices 21 and 22 are provided for monitoring the return flow either of the fuel mixture or of the starter fuel.

All units are governed by a central control unit 23. This control unit 23 is connected by line 24 with the booster pump 6, by line 25 with the switching valve 17, by line 26 with the conveying pump 15, and by line 27 with the switching valve 19. Also, the control devices 21 and 22 are connected by control lines 27 and 28 with the control unit 23 so that the latter can send out and receive electrical signals in order to control the respective pumps and valves connected to the control unit 23 and to receive corresponding signals from the control units for further control processes.

When the control unit detects that the internal combustion engine is switched off, it switches the switching valve 17 into starter mode so that the supply line 18 for the fuel mixture is closed. In parallel, the booster pump 6 receives a signal from the control unit 23 and shuts down. The conveying pump 15 is switched on so that by means of the removal valve 14 the starter fuel such as diesel fuel is supplied through the supply line 16 into the supply line 18 and for a subsequent starting process is supplied at a higher pressure by means of the high-pressure pump 7 to the injection system 9, 10 so that the starting process with the starter fuel can be realized wherein, prior to this, possible bubbles of the fuel mixture are carried away. When during the starting phase excess starter fuel is present, the latter can be returned via the switching valve 19 through the return line 20 to the tank 13 for the starter fuel. When the internal combustion engine is operating again, the control unit 23 switches off the starter unit with the pump 15. The switching valves 17 and 19 are switched and the booster pump 6 is activated again so that switching to the normal operation with fuel mixture is realized.

What is claimed is:

1. A fuel metering device in particular for a self-igniting air-compressing internal combustion engine, comprising a fuel pump (6) for conveying a fuel, wherein the fuel can be removed from a tank and supplied via a high pressure pump (7) to an injection system (9, 10) of the internal combustion engine and wherein excess fuel can be returned from the injection system (9, 10) via a return line (11) in the injection system, and wherein the tank is a pressure mixing container (19) having a vapor pressure buffer chamber for receiving a first fuel, selected from the group consisting of diesel fuel, rapeseed oil, soybean oil, sunflower seed oil, palm oil and fats, and a second fuel such as liquefied petroleum gas (LPG fuel), and a pressurized fuel mixture that is formed from the first fuel and the second fuel is removable from the pressurized mixing container (12) via a removal valve (5) and can be supplied to the high-pressure pump (7) of the injection system (9, 10) via the fuel pump (6) designed as a booster pump, wherein the removal of the pressurized fuel mixture is realized via the removal valve (5) via a wall that is arranged in the lower area of the pressurized mixing container (12) so that a static pressure loads the removal valve (5) and wherein the booster pump is arranged downstream of the removal valve in the flow direction of the fuel mixture outside of the pressurized mixing container (12), wherein, in the flow direction of the fuel downstream of the fuel pump (5) and upstream of the injection system (9, 10), an overpressure and bypass valve (8) is provided for returning the fuel mixture through the return line (11) into the pressurized mixing container.

2. The fuel metering device according to claim 1, wherein the pressure mixing container (12) is furnished with a filling valve (2) for the first fuel and with a filling valve (2) for the second fuel, and the first fuel and the second fuel are separately feedable to the pressurized mixing container (12), respectively, wherein within the pressurized mixing container (12) the pressurized fuel mixture is automatically produced.

3. The fuel metering device according to claim 1, wherein in a fuel mixture line extending between the removal valve (5) and the high-pressure pump (7) the booster pump (6) is arranged and between the high-pressure pump (7) and the booster pump (6) the overpressure and bypass valve (8) is arranged, wherein the fuel mixture can be returned to the pressurized mixing container (12) via the overpressure and bypass valve (8).

4. The fuel metering device according to claim 1, wherein between the fuel injection system (9, 10) and the high-pressure pump (7) an overpressure and bypass valve (8) is arranged and the fuel mixture can be returned to the pressurized mixing container (12) via the overpressure and bypass valve (8).

5. The fuel metering device according to claim 1, further comprising a safety valve (1) arranged on the pressurized mixing container (12) in the area of the vapor pressure buffer chamber.

6. The fuel metering device according to claim 1, further comprising a housing guard provided on all valves on the pressurized mixing container (12).

7. The fuel metering device according to claim 1, further comprising a spring-loaded non-return device adapted to protect the removal valve (5) within the pressurized mixing container (12).

8. A fuel metering device in particular for a self-igniting air-compressing internal combustion engine, comprising a fuel pump (6) for conveying a fuel, wherein the fuel can be removed from a tank and supplied via a high pressure pump (7) to an injection system (9, 10) of the internal combustion engine and wherein excess fuel can be returned from the injection system (9, 10) via a return line (11) in the injection system, and wherein the tank is a pressure mixing container (19) having a vapor pressure buffer chamber for receiving a first fuel, selected from the group consisting of diesel fuel, rapeseed oil, soybean oil, sunflower seed oil, palm oil and fats, and a second fuel such as liquefied petroleum gas (LPG fuel), and a pressurized fuel mixture that is formed from the first fuel and the second fuel is removable from the pressurized mixing container (12) via a removal valve (5) and can be supplied to the high-pressure pump (7) of the injection system (9, 10) via the fuel pump (6) designed as a booster pump further comprising a second tank (13) with a vapor pressure buffer chamber for receiving the first fuel as a starter fuel is provided and from this tank (13) by means of a conveying pump (15) the starter fuel can be removed and via the high-pressure pump (7) supplied to the injection device (9, 10), wherein the booster pump (6) of the pressurized mixing container (12) and the conveying pump (15) of the tank (13) of the starter fuel as well as a switching valve (17) in the supply line (18) of the fuel mixture are controlled by a control unit (23).

9. The fuel metering device according to claim 8, wherein in a supply line (16) from the conveying pump (15) of the tank (13) for the starter fuel up to the switching valve (17) an overpressure valve is provided for returning the starter fuel into the tank (13) for the starter fuel.

10. The fuel metering device according to claim 8, wherein in front of the switching valve (17) the overpressure and bypass valve (8) for the fuel mixture of the pressurized mixing container (12) is provided.

11. The fuel metering device according to claim 8, wherein the fuel injection device (9, 10) has correlated therewith a return line (11) for the pressurized mixing container and a return line (28) for the starter fuel to the tank (13) of the starter fuel, wherein a switching valve (19) to be switched by a control unit (23) is provided for the return flow (11) of the fuel mixture and the return flow (20) of the starter fuel.

12. The fuel metering device according to claim 11, wherein in the return line (11) for the fuel mixture in the flow direction downstream of the switching valve (19) and in the return line (28) to the tank (13) of the starter fuel a control device (21 or 22) for the return flow is provided, respectively, wherein the control devices (21, 22) are connected to the control unit (23).
